(19) United States
(12) Patent Application Publication
(10) Pub. No.: US 2020/0314203 A1
(43) Pub. Date: Oct. 1, 2020

(54) DYNAMIC ADJUSTMENT OF A USER PROFILE

(71) Applicant: Lenovo (Singapore) Pte. Ltd., Singapore (SG)

(72) Inventors: Mark Patrick Delaney, Raleigh, NC (US); Nathan J. Peterson, Oxford, NC (US); Russell Speight VanBlon, Raleigh, NC (US); Arnold S. Weksler, Raleigh, NC (US); John Carl Mese, Cary, NC (US)

(21) Appl. No.: 16/366,763

(22) Filed: Mar. 27, 2019

(51) Int. Cl. H04L 29/08; H04L 12/58

(52) U.S. Cl. CPC H04L 67/306; H04L 51/32

(57) ABSTRACT

One embodiment provides a method, including: receiving, at an application platform, an indication that a viewing user has access to a user profile; identifying, using a processor, a characteristic associated with the viewing user; adjusting an aspect of the user profile based upon the identified characteristic; and presenting the user profile to the viewing user with the adjusted aspect. Other aspects are described and claimed.

### BACKGROUND

Many social media platforms allow a user to create a user profile. The user profile may comprise a variety of different types of identifying information about the user such as, inter alia, a user profile image, user interests, political and/or social group affiliations, other types of identifying information, and the like. Information uploaded to the user profile may thereafter be publicly displayed and made accessible to other users of the social media platform.

### BRIEF SUMMARY

In summary, one aspect provides a method, comprising: receiving, at an application platform, an indication that a viewing user has access to a user profile; identifying, using a processor, a characteristic associated with the viewing user; adjusting an aspect of the user profile based upon the identified characteristic; and presenting the user profile with the adjusted aspect to the viewing user.

Another aspect provides an information handling device, comprising: a processor; a memory device that stores instructions executable by the processor to: receive, at an application platform, an indication that a viewing user has access to a user profile; identify a characteristic associated with the viewing user; adjust an aspect of the user profile based upon the identified characteristic; and present the user profile with the adjusted aspect to the viewing user.

A further aspect provides a product, comprising: a storage device that stores code, the code being executable by a processor and comprising: code that receives an indication that a viewing user has access to a user profile; code that identifies a characteristic associated with the viewing user; code that adjusts, based on the identifying, an aspect of the user profile based upon the characteristic; and code that presents, to the viewing user when the viewing user views the user profile, the user profile with the adjusted aspect.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of adjusting an aspect of a user profile based upon one or more characteristics of a viewing user.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

In today's age, social and professional networking and relationship development commonly occurs online. More particularly, the rise of social media (e.g., FACEBOOK, INSTAGRAM, TWITTER, etc.) and online professional communities (e.g., LINKEDIN, etc.) allow users to connect in ways that they never could before. FACEBOOK is a registered trademark of Facebook, Inc. in the United States and other countries. INSTAGRAM is a registered trademark of Instagram, LLC. in the United States and other countries. TWITTER is a registered trademark of Twitter, Inc. in the United States and other countries. LINKEDIN is a registered trademark of Linkedin Corporation in the United States and other countries.

Users of the aforementioned online social and professional platforms may be able to create a user profile comprising various types of user information. For instance, a standard user profile typically contains a profile image and a brief description or biography of a user. The formality of the content in the user profile may vary widely based upon the intent of the user profile and/or the type of platform it is being created for (e.g., social vs. professional, etc.).

An issue with conventional user profiles is that they are largely static in nature. More particularly, all users of a platform may view the same content when looking at a particular profile. However, situations may arise where a user may want the information displayed on their profile to be presented a certain way to different individuals and/or different classes of individuals. For example, a user may want their user profile to appear one way when viewed by their professional co-workers and a different way when viewed by their college friends. Although mechanisms exist that allow a user to adjust certain privacy settings associated with their profile to designate the types of content that are publicly visible, these mechanisms do not consider the different characteristics of and relationships to a viewing user when displaying profile information.

Accordingly, an embodiment provides a method for adjusting one or more aspects of a user profile based upon an identified characteristic of a viewing user. In an embodiment, an indication may be received at an application platform that a viewing user has access to a user profile. An embodiment may identify one or more user characteristics associated with the viewing user and then adjust one or more aspects of the user profile (e.g., adjust a profile picture, biography, interests, group affiliations, etc.) based upon the identified characteristic(s). For example, an embodiment may adjust the user interests of a user profile to match the identified interests of a viewing user. Thereafter, an embodiment may present the adjusted user profile to the viewing user while the viewing user is browsing through the user profile. Such a method may provide contextually relevant profile information to viewers of a user profile.

The illustrated example embodiments will be best understood by reference to the figures. The following description is intended only by way of example, and simply illustrates certain example embodiments.

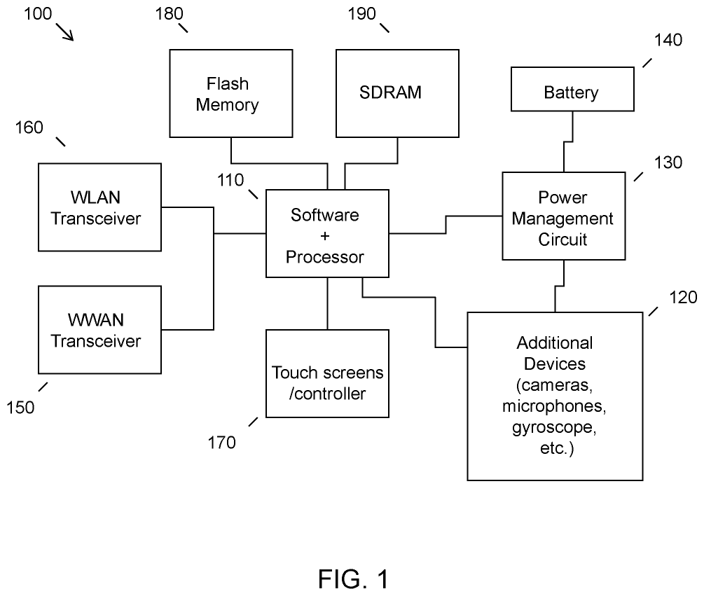

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera, audio capture device such as a microphone, motion sensor such as an accelerometer or gyroscope, etc. System 100 often includes one or more touch screens 170 for data input and display/rendering. System 100 also typically includes various memory devices, for example flash memory 180 and SDRAM 190.

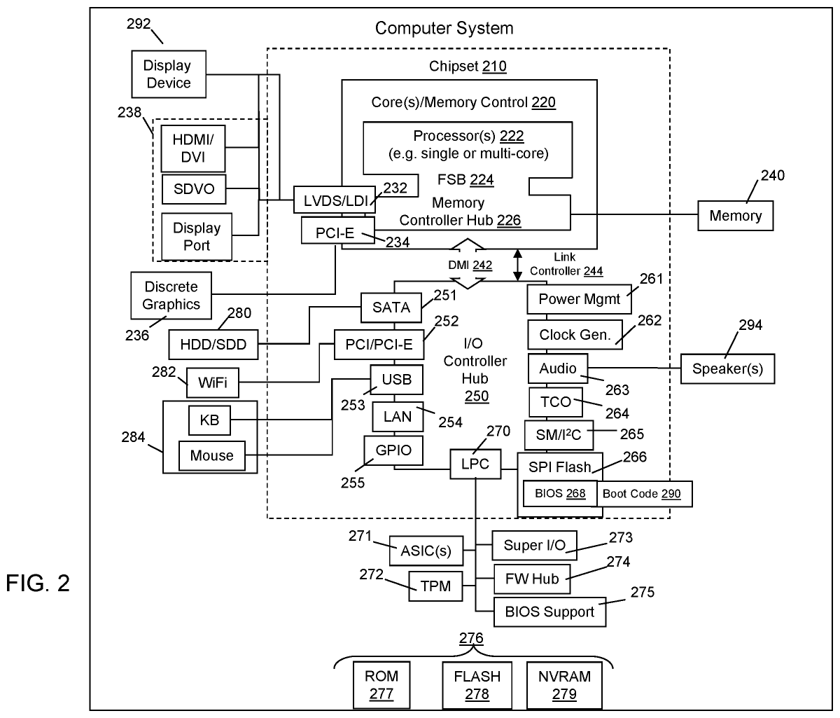

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as smart phones, tablets, laptops, and/or electronic devices that may support access to one or more online social media applications and/or websites. For example, the circuitry outlined in FIG. 1 may be implemented in a tablet or smart phone embodiment, whereas the circuitry outlined in FIG. 2 may be implemented in a laptop.

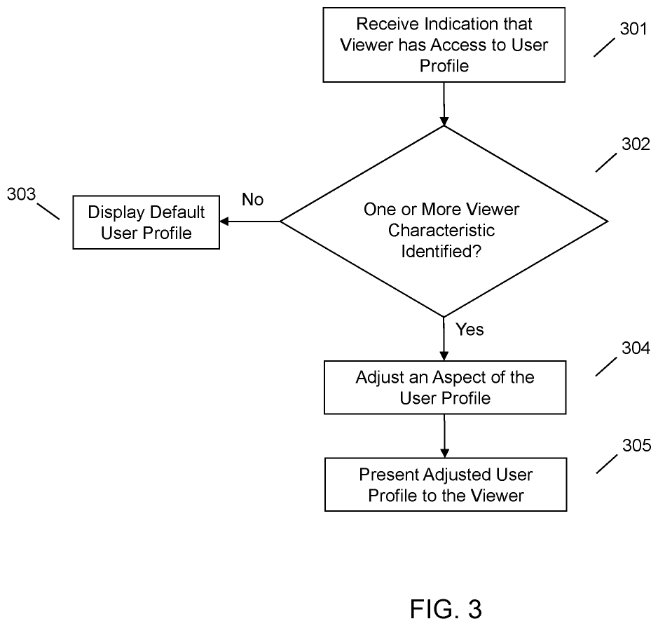

Referring now to FIG. 3, an embodiment may dynamically display information in a user profile relative to a viewing audience. At 301, an embodiment may receive an indication that a viewing user has access to a user profile on an application platform. In the context of this application, a user profile may comprise one or more user-defining aspects. For example, the user profile may be as simple as comprising a profile image, or avatar, for a user in a group chat or as complex as comprising one or more full pages containing various descriptive textual information and media (e.g., images, videos, etc.) associated with the user. In the context of this application, an application platform may correspond to virtually any type of digital group, website, or application that may allow a user to create a user profile that may be viewable by one or more other users.

In an embodiment, an indication of access may be as simple as identifying that a viewing user (“viewer”) has also registered or created a user profile with the application platform. In another embodiment, the indication may be received when it is identified that the viewer is presently using the application platform (e.g., when the user has logged into the application platform, when the application platform is an active application on the viewer's device, etc.). In yet another embodiment, an indication of access may relate to identifying that the viewer is an authorized member/participant in a group on an application platform (e.g., a viewer is a member of a group chat on a chatting application, etc.).

At 302, an embodiment may identify one or more characteristics associated with the viewer. In the context of this application, a characteristic may be virtually any data point that may provide some sort of identifying information about the viewer (e.g., a viewer's interests, location, affiliations, social relationships, etc.). The relevant data points may be contained in a user profile associated with the viewer (e.g., in a viewer's profile image, profile biography, other profile media, etc.) or may be obtained from other outside sources. More particularly, with respect to the latter, if an embodiment has access to other sources comprising information about the viewer (e.g., other social media platforms, email or SMS text message communications, attached metadata, other online sources, etc.), an embodiment may analyze this available outside information to identify any other viewer defining characteristics.

In an embodiment, the identification of the characteristic(s) may be conducted using a variety of different characteristic detecting techniques. For instance, an embodiment may employ one or more conventional image and/or video analysis techniques to analyze a viewer's profile image, or to analyze other media objects contained in the viewer's profile or other accessible outside sources, to identify any viewer defining characteristics. For example, an embodiment may attempt to identify the presence of any: organization logos (e.g., logos affiliated with universities, sports teams, political groups, etc.), location identifying landmarks (e.g., notable buildings, structures, landscapes, etc.), people (e.g., other identifiable application platform users, celebrities, political figures, etc.), animals (e.g., dogs, cats, other pets, etc.), and the like. Similar text-based analysis techniques may be conducted on various text objects present in the viewer's profile or other accessible outside sources.

Responsive to not identifying, at 302, at least one characteristic associated with the viewer, an embodiment may, at 303, present information contained in a user's profile in a conventionally static manner. Alternatively, when characteristic information about a viewer cannot be identified, an embodiment may display a default user profile which may contain, for example, a basic or neutral user profile image (e.g., an image of a user smiling at a camera, etc.) and/or profile information (e.g., a user's name, occupation, etc.). Conversely, responsive to identifying at least one characteristic associated with the viewer, an embodiment may, at 304, adjust an aspect of the user profile based upon the identified characteristic(s) and present, at 305, the adjusted profile to the viewer. In an embodiment, the adjustment and presentation may occur automatically and without additional user input.

In an embodiment, the adjustment of the aspect may correspond to replacement of one or more of: a user's default profile image, a portion of a default profile biography, other default profile media and/or text objects, and the like, to another corresponding media or text object. To implement the adjustment, an embodiment may access a data store (e.g., stored on the application platform, on the user's device, on another device or server, etc.) comprising a variety of different types of media and/or text objects that an embodiment has permission to use as replacements for the existing default profile objects.

In an embodiment, aspects of the user profile may be adjusted to share a certain level of commonality with an identified viewer characteristic. For example, responsive to identifying that a viewer is a fan of a certain sports team (e.g., by identifying that the viewer was wearing a hat comprising a logo for the sports team in their profile picture, etc.), an embodiment may access the aforementioned data store to determine if any images or text objects exist of the user expressing their mutual support for the sports team. If a match is identified, e.g., by identifying an image of the user wearing a sweater with the team's name and/or logo, etc., an embodiment may replace the user's profile picture with the identified image. As another example, responsive to identifying that a viewer is a member of an animal cruelty prevention group (e.g., from an analysis of the occupation or group affiliation data in the viewer's profile, etc.), an embodiment may adjust the listed interests of a user in their profile to include support for pets.

In an embodiment, the adjustment may also involve adjusting a position and/or a presentation of certain types of information in a user's profile. More particularly, if similarities are identified between the user and the viewer, those similarities may be emphasized to the viewer in some way. For example, an embodiment may dynamically move existing aspects of the user profile corresponding to those similarities to a more prominent viewing location (e.g., to the top of the user profile, etc.). Alternatively, an embodiment may visually distinguish (e.g., by highlighting, etc.) these similarities from the surrounding profile information.

In an embodiment, the adjustment of the aspect may correspond to presentation of a completely pre-constructed user profile specific to an identified characteristic. For instance, a user may create a plurality of different user profiles that may be automatically displayed to viewers comprising certain characteristics. As an example, responsive to identifying that a viewer is affiliated with a particular political group, an embodiment may present to that viewer a user profile comprising images and/or other textual indications of the user also supporting the same political group.

In the context of this application, presentation of the adjusted user profile to the viewer may correspond to the presentation of the user profile on the viewer's device. In an embodiment, the presentation of the adjusted user profile may occur when the viewer is viewing an aspect of the user profile. For instance, the presentation may occur when a viewer visits a user's profile page or sees a user's profile image next to the user's name in a group chat, online forum, etc. In an embodiment, two or more adjusted user profiles may be simultaneously presented to two or more simultaneous viewers of the user profile. For example, a user's profile picture may appear one way to Viewer A in a group chat or forum whereas the profile picture may appear a different way to Viewer B in the group chat or forum, where Viewer B is viewing the user's profile substantially simultaneously with Viewer A.

In an embodiment, if multiple characteristics of a viewer are identified then an embodiment may adjust multiple aspects of a default profile. For example, if an embodiment identifies that a viewer supports a sports team supported by the user and also previously attended a university attended by the user, then an embodiment may adjust one or more aspects of the user's default profile to indicate and/or emphasize these similarities. Alternatively, in situations where multiple characteristics of a viewer are identified, an embodiment may choose a single characteristic by which to adjust the profile. For instance, an embodiment may choose the viewer characteristic that is most prominently displayed in the viewer's profile (e.g., the characteristic that appears the most, etc.). Alternatively, an embodiment may choose the viewer characteristic for which similar user information can be found in the data store. Alternatively, in another example, an embodiment may provide a list of identified characteristics of the viewer and request the user to identify a characteristic from the list.

The various embodiments described herein thus represent a technical improvement to conventional methods for presenting a user profile. Using the techniques described herein, an embodiment may receive an indication that a viewer has access to a user profile. An embodiment may then identify a characteristic associated with the viewer and thereafter adjust an aspect of the user profile based upon the characteristic (e.g., to share a similar with the characteristic, etc.). An embodiment may then present the adjusted user profile to the viewer (e.g., when the viewer is looking at the user profile, etc.). Such a method may allow users to automatically present a contextually relevant user profile to each viewer of the profile.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

1. A method, comprising:
receiving, at an application platform, an indication that a viewing user has access to a user profile;
identifying, using a processor, a characteristic associated with the viewing user wherein the characteristic corresponds to an interest of the viewing user;
determining that the user profile shares an indication of the interest;
adjusting an aspect of the user profile based upon the identified characteristic, wherein the aspect corresponds to text-based information associated with the interest and wherein the adjusting comprises emphasizing, in the user profile, the text-based information over other profile aspects; and
presenting the user profile with the adjusted aspect to the viewing user.

2. The method of claim 1, wherein the aspect of the user profile is associated with at least one text object or media object.

3. The method of claim 2, wherein the adjusting comprises adjusting at least one of the text object or the media object to another text object or another media object.

4. The method of claim 1, wherein the adjusting comprises automatically adjusting the aspect of the user profile without additional user input.

5. The method of claim 1, wherein the adjusting comprises adjusting the aspect to another aspect sharing a commonality with the characteristic.

6. The method of claim 1, wherein the identifying comprises analyzing a profile characteristic associated with the viewing user.

7. The method of claim 6, wherein the profile characteristic comprises data selected from the group consisting of a viewing user profile image, a viewing user profile page, and outside data associated with the viewing user.

8. The method of claim 1, wherein the presenting comprises presenting the adjusted aspect to the viewing user during viewing of the user profile by the viewing user.

9. The method of claim 1, wherein the characteristic comprises a plurality of characteristics and wherein the adjusting comprises selecting a characteristic from the plurality on which to base the adjusting.

10. The method of claim 1, further comprising presenting, to another viewing user while the viewing user views the user profile, the user profile with a different adjusted aspect, wherein the different adjusted aspect is based upon a characteristic of the another viewing user.

11. An information handling device, comprising:
a processor;
a memory device that stores instructions executable by the processor to:
receive, at an application platform, an indication that a viewing user has access to a user profile;
identify a characteristic associated with the viewing user, wherein the characteristic corresponds to an interest of the viewing user;
determine that the user profile shares an indication of the interest;
adjust an aspect of the user profile based upon the identified characteristic, wherein the aspect corresponds to text-based information associated with the interest and wherein the adjusting comprises emphasizing, in the user profile, the text-based information over other profile aspects; and
present the user profile with the adjusted aspect to the viewing user.

12. The information handling device of claim 11, wherein the aspect of the user profile is associated with at least one text object or media object.

13. The information handling device of claim 11, wherein the instructions executable by the processor to adjust comprise instructions executable by the processor to adjust at least one of the text object or the media object to another text object or another media object.

14. The information handling device of claim 11, wherein the instructions executable by the processor to adjust comprise instructions executable by the processor to automatically adjust the aspect of the user profile without additional user input.

15. The information handling device of claim 11, wherein the instructions executable by the processor to adjust comprise instructions executable by the processor to adjust the aspect to another aspect sharing a commonality with the characteristic.

16. The information handling device of claim 11, wherein the instructions executable by the processor to identify the characteristic comprise instructions executable by the processor to analyze a profile characteristic associated with the viewing user.

17. The information handling device of claim 16, wherein the profile characteristic comprises data selected from the group consisting of a viewing user profile image, a viewing user profile page, and outside data associated with the viewing user.

18. The information handling device of claim 11, wherein the characteristic comprises a plurality of characteristics and wherein the instructions executable by the processor to adjust comprise instructions executable by the processor to select a characteristic from the plurality on which to base the adjusting.

19. The information handling device of claim 11, wherein the instructions are further executable by the processor to present, to another viewing user while the viewing user views the user profile, the user profile with a different adjusted aspect, wherein the different adjusted aspect is based upon a characteristic of another viewing user.

20. A product, comprising:
a storage device that stores code, the code being executable by a processor and comprising:
code that receives an indication that a viewing user has access to a user profile;
code that identifies a characteristic associated with the viewing user, wherein the characteristic corresponds to an interest of the viewing user;
code that determines that the user profile shares an indication of the interest;
code that adjusts, based on the identifying, an aspect of the user profile based upon the characteristic, wherein the aspect corresponds to text-based information associated with the interest and wherein the adjusting comprises emphasizing, in the user profile, the text-based information over other profile aspects; and
code that presents, to the viewing user when the viewing user views the user profile, the user profile with the adjusted aspect.
